(19) United States
(12) Patent Application Publication
(10) Pub. No.: US 2022/0082093 A1
(43) Pub. Date: Mar. 17, 2022

(54) SEQUENTIAL IMPULSE THRUSTER

(71) Applicant: Taoufik HICHAM, Marrakech (MA)

(72) Inventor: Taoufik HICHAM, Marrakech (MA)

(21) Appl. No.: 17/423,513

(22) PCT Filed: Oct. 20, 2020
(86) PCT No.: PCT/MA2020/000009

§ 371 Date: Jul. 16, 2021

(30) Foreign Application Priority Data
Dec. 3, 2019 (MA) 47560

(51) Int. Cl. F03H 1/00

(52) U.S. Cl. CPC F03H 1/0087

(57) ABSTRACT

The sequential impulse thruster is a system intended to provide permanent thrust to any vehicle to which it can be applied. The thrust by the system is the result of the repulsion of a perforated disc with several holes subsequent to the expulsion of compressed air or gas through the holes of the perforated disc. The compressed air or gas is expelled in sequential impulses within a hermetic frame. In order to achieve the thrust, the system is based on the organization of a set of components: a flanged and threaded axis of rotation, two types of propellers, one to realise sequences of expulsions and the other as a potential for the flowback, a perforated disc with several holes, and finally, a tube which allows separation between the expulsion of air or compressed gas and its flowback towards its pressure source.

### CROSS REFERENCE TO THE RELATED APPLICATIONS

This application is the national phase entry of International Application No. PCT/MA2020/000009, filed on Oct. 20, 2020, which is based upon and claims priority to Moroccan Patent Application No. 47560, filed on Dec. 3, 2019, the entire contents of which are incorporated herein by reference.

### TECHNICAL FIELD

This invention relates to a sequential impulse thruster, in which the thrust results from the repulsion of a disc with several holes opposed to the expulsion of compressed air within the hermetic frame of the thruster.

### BACKGROUND

Nowadays, technology has not been able to present a system allowing a vehicle permanent and controlled thrust in a space outside Earth atmosphere.

### SUMMARY

The sequential impulse thruster is a system intended to achieve thrust using expulsion of compressed air. This compressed air is expelled in the form of sequential impulses within a hermetic frame. The thrust realized by the system results from the repulsion of a disc with several holes opposed to the expulsion of compressed air within the hermetic frame of the thruster.

Nowadays, technology has not been able to present a system allowing a vehicle permanent and controlled thrust in a space outside Earth atmosphere, with the exception of this new system concerning the sequential impulse thruster.

However, the thruster must be associated with an electric motor or with a magnetic motor.

Whatever the type of the motor associated with the thruster, it is external to the subject matter of the present invention.

The sequential impulse thruster offers a system with a new concept. It allows permanent thrust in atmospheric space and/or outside the Earth's atmosphere.

Currently, the means deployed for the movement of any vehicle are essentially based on the fuel combustion. These reaction means are expensive and become active only in atmospheric space.

Renewable energies and fossils fail to meet the constant demand needs. To reduce energy dependence related to the movement of our vehicles. The sequential impulse thruster, preferably associated with the magnetic motor which does not release any harmful material, represents a new alternative system.

The sequential impulse thruster has several advantages: first, to allow per unit or per a group of thrusters a thrust force on par with any need.

Second, it allows to provide a thrust system which takes into account safety, ease of manufacture, low production cost, reliability in use and a wider scope of application.

It also allows to provide a system which takes into account all the possibilities of adaptation. For example, the installation of a sequential impulse thruster can be fix or mobile. For a vehicle moving in atmospheric space, the thruster can be fixed to the vehicle. Instead, for its evolution outside the Earth atmosphere, the thruster must be held to the aircraft vehicle by a system allowing it several orientations, so as to be able to direct it towards the direction desired and its slowing down upon entering the Earth's atmosphere. (The speed of entry into the atmosphere is equal to that of exit).

The system can also be applied to the action of an electric generator. For example, a number of thrusters can be fixed around one or more wheels carried by the shaft of the electric generator.

The comparative test between an aircraft reactor and a sequential impulse thruster allows to identify a few differences between the two concepts:
The propeller of an aircraft engine is shaped to compress atmospheric air. Instead, that of a sequential impulse thruster is shaped to realize expulsions sequences.
The expulsion of compressed air from an aircraft engine is a continuous expulsion. Instead, that of a sequential impulse thruster occurs in sequential impulses.
The air compressed by an aircraft reactor is continuously subtracted from atmospheric space while being expelled into a relatively open space. Instead, the compressed air of a sequential impulse thruster is confined within a hermetic frame while being expelled in sequential impulses in a closed circuit.

The sequential impulse thruster is a system intended to achieve movement by permanent thrust. The latter requires the stability and maintenance of the geometry of the system. So, the hermetic frame must be made of a rigid material, it must withstand the pressure and avoid the torsion of the system, and it also allows to keep in place all the elements necessary for the good functioning of the system.

### BRIEF DESCRIPTION OF THE DRAWINGS

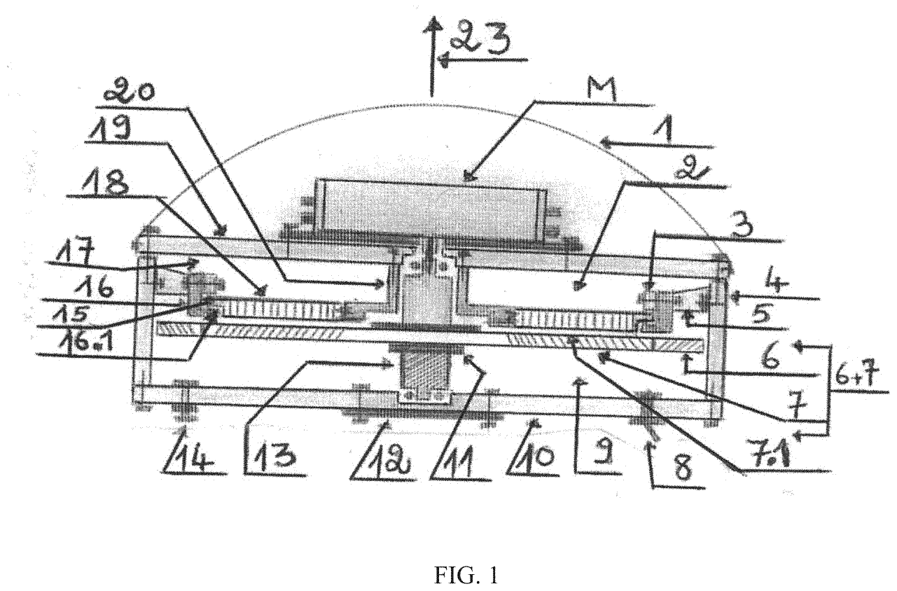

FIG. 1 is the illustration of a system formed by a single set of expulsion (7 and 18); wherein:
1: spherical segment;
2: expulsion source;
3: ring (it supports the repulsion of the disc);
4: hermetic frame;
5: fixation means (Rigid), they are fixed around the separation tube (16) and to the hermetic frame (4);
6: backflow propeller;
7: sequence propeller;
7.1: space between fins;
8: compression valve;
9: backflow source;
10: cover;
11: assembly nut;
12: reinforcement plate (against pressure);
13: flanged and threaded axis (of rotation);
14: pressure-relief valve;
15: disc collar;
16: separation tube (comprising a collar);
16.1: collar inside the separation tube;
17: outlet of compressed air flow;
18: perforated disc with several holes (threaded from inside);
19: cover;
20: support fixed to the disc (18) by thread (allows to assist the ring (3) during the repulsion of the disc (18));
23: thrust direction;
M: motor.

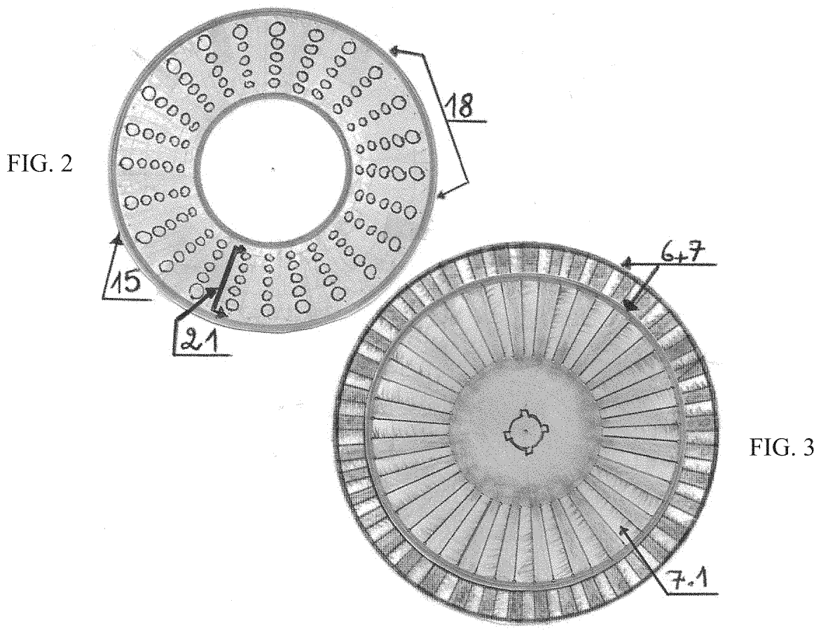

FIG. 2 is the illustration of a perforated disc with several holes; preferably, the thickness of the disc should be adequate to the thrust force; wherein:
18: perforated disc with several holes (threaded from inside);
15: disc collar (FIG. 1, (18))
21: an alignment of disc holes (FIG. 1, (18)).

FIG. 3 is the illustration of a combined propeller between a backflow propeller and a sequence propeller; wherein:
6+7: combined propellers;
7.1: space between fins.

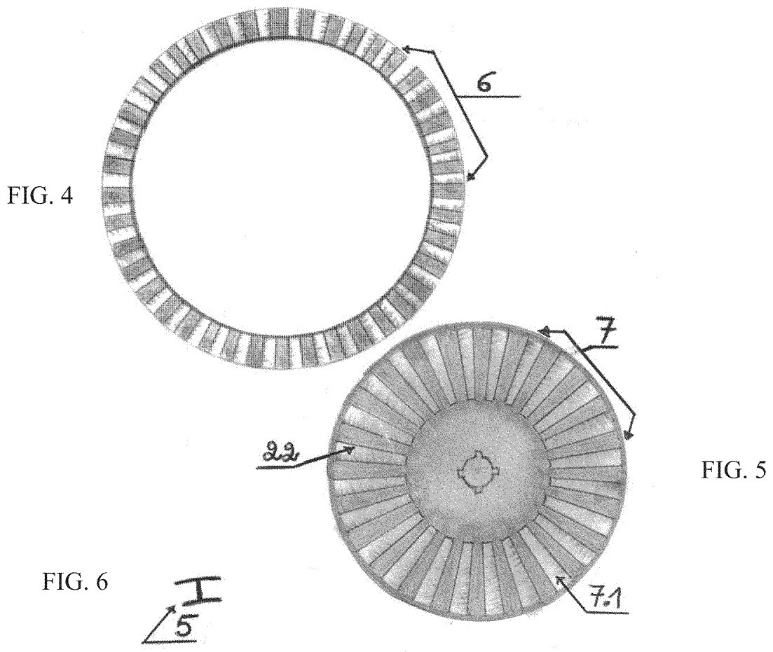

FIG. 4 is the illustration of a flowback propeller; wherein:
6: backflow propeller;

FIG. 5 is the illustration of a sequence propeller; wherein;
7: sequence propeller;
7.1: space between fins;
22: a fin of sequence propeller (FIG. 1, (7));

FIG. 6 is the illustration of one of rigid fixation means; wherein:
5: Fixation means (rigid).

### DETAILED DESCRIPTION OF THE EMBODIMENTS

The system of a sequential impulse thruster requires for its conception: the organization of a set of components, the presence of compressed air within a hermetic frame and a motive power supply.

For this, the sequential impulse thruster intended to produce a thrust by expelling compressed air within a hermetic frame (4) comprising two covers (10), (19), a compression valve (8), a pressure-relief valve (14), a reinforcement plate (12), a flanged and threaded axis (13), a flowback source (9) and at least one expulsion set (7 and 18), each set consists of a perforated disc with several holes (18) and a sequence propeller (7), the latter is fixed while being carried by a flanged and threaded axis (13) of rotation, the disc (18) fixed to support (20) by thread and mounted by contact of collars (15) and (16.1) to the separation tube (16), the contact of collars fixed by ring (3), the separation tube fixed to the hermetic frame by fixation means (5) having a diameter smaller than that of the frame, the space between the tube and the frame allows a potential backflow propeller (6) to flow back the expelled air towards its source of expulsion (2) by the outlet of the compressed air flow (17) and that the compressed air within the hermetic frame is expelled in sequential impulses through the holes of the disc (18), towards the space between fins (7.1) of the sequence propeller (7) the expelled compressed air in sequential impulses causes the repulsion of the disc (18) during the supply of motive power of motor (M) actuating the flanged and threaded axis (13) of rotation (the motive power of motor (M) is external to the subject matter of the present invention).

The process of thrust by the expulsion of compressed air and the repulsion of the disc this refers to the notion: (Action-Reaction).

The potential backflow propeller (6) is recommended if the measure of the space between (18) and (19) and that between (7) and (10) are high; in other words if the volume of the source of expulsion (2) and that of the flowback source (9) are high.
The space between the fins (7.1) of the sequence propeller (7) allows the compressed air to be expelled in sequential impulses through the holes of the disc (18) and allows the arrival of the air flow to the flowback source (9).
The expulsion of the compressed air in sequential impulses is granted by the fins of the sequence propeller (7) during the supply of motive power of motor (M) actuating the flanged and threaded axis (13) of rotation and the measurement of the width of a fin between two alignments of the holes (FIG. 2, (21)) is preferably equal to the diameter of said holes.
The sequence propeller (7) comprising various fins which are shaped so that each fin has shadow on the fin which follows it, and that each fin must have a facet.
One of the two surfaces composing the perforated disc with several holes (18) comes close to the limit of contact with the facets of the fins which are exposed to it by the sequence propeller (7), so that the facets of the fins close and then open all the holes of the disc (18), in order that the compressed air is expelled in sequential impulses through the holes of the disc (18) during the supply of motive power of motor (M) actuating the flanged and threaded axis (13) of rotation.

Preferably, the number of fins (FIG. 2, (21)) is equal to the number of alignments of disc holes (FIG. 5, (22)).
The compressed air can be replaced by a compressed fluid or by a set of particles releasing a pressure within the hermetic frame of the thruster.

The compressed air flow is looped, it rebalances instantly the pressure between the expulsion source (2) and the backflow source (9) within the hermetic frame (4), the volume of the compressed air expelled in sequential impulses through the holes of the disc (18) towards the backflow source (9) is equal to that flowed back towards the expulsion source (2) through the outlet of compressed air flow (17).

Preferably, the compressed air within the hermetic frame (4) be of a high pressure and the rotation of the propeller be of high speed.

It is preferable that the volume of the compressed air of the backflow source (9) is equal to that of the expulsion source (2). However, the system produces thrust despite the difference of volume between (2) and (9).
The sequential impulse thruster is driven by a rotating motor (M) coupled with a flanged and threaded axis (13) allowing the thruster to maintain its pressure within the hermetic frame (4) and produce a thrust.
The thrust results from the opposition between the expulsion of the compressed air in sequential impulses at the moment of its release through the holes of the disc (18) and the repulsion of this disc, the said holes of the disc and the space between the fins (7.1) can be replaced by other geometric forms.

For example, the space between the fins (7.1) can be replaced by holes of a (sequences) disc, so the sequence propeller (7) can take the form of a perforated (sequences) disc of several holes; these latters configured under helicoidal form. The arrangement and the number of the holes of the (sequences) disc are identical to the holes of the disc (18) in order that the compressed air is expulsed in sequential impulses through the holes of the disc (18) towards the holes of the (sequences) disc.
Use of the sequential impulse thruster or a grouping of sequential impulse thrusters, each thruster of which comprises at least one expulsion set (7 and 18), each set consists of a perforated disc of several holes (18) and a sequence propeller (7), the latter is fixed while being carried by a flanged and threaded axis (13), a motor (M), (the motive power is external to the subject matter of the present invention), the disc (18) fixed to support (20) by thread and mounted by contact of collars (15) and (16.1) to the separation tube (16), the contact of collars fixed by ring (3), the separation tube fixed to the hermetic frame (4) by fixation means (5) having a diameter smaller than that of the hermetic frame, the space between the tube and the frame allows to a potential backflow propeller (6) to flow back the expelled air towards its source of expulsion (2) by the outlet of the compressed air flow (17), and that the air compressed within the hermetic frame is expelled in sequential impulses through the holes of the disc (18) within the hermetic frame (4) which is a component and inseparable part of an aerospace vehicle, a navigating vehicle, a rolling vehicle, or a machine generating electricity.

Example of Potentiality:

A bar compressor (inflator) of 6 bars, expelling air through a 2-millimeter hole, lifts around 200 grams.

Example of Potentiality:

A frame containing a pressure of 300 bars, theoretically 300/6=50 bars multiplied by 200 grams=10 kg. A thruster with a disc 1.3 meters in diameter and a number of (2000 holes multiply by 10)=20 tons. If the thruster only lift 2 tons, then 10 sets of expulsion (7 and 18) spaced in parallel (without support (20)) can lift 20 tons.

The number of revolutions per minute of the propellers is estimated to 4000.

N.B: no exact confirmation of the example cited, except that of the compressor.

However, persons skilled in the art have the skills required to produce a sequential impulse thruster, without being out of the scope of the present invention.

The system of a sequential impulse thruster can be presented in various embodiments. For this, a basic model is proposed, the realization of which is designed by a single set of expulsion (7 and 18). This model offers one of the possibilities to produce a thrust. In this regard, six drawings are proposed: an embodiment model, also illustrated by its description (FIG. 1), as well as the model of some components of the system (FIGS. 2-6).

The phases of assembly of a basic model concerning the sequential impulse thruster are as follow:

1. Fix the fixation means (FIG. 1, (5)) to the hermetic frame, (FIG. 1, (4)).

2. according to the drawing (FIG. 1), put in contact the collar (15) of the perforated disc (18) on the collar (16.1) of the separation tube (16), fix the support (20) by thread to the disc (18), fix (16) to (3) and (5).

The above cited process is conceived by one collar (15) around the disc (18), another collar (16.1) inside the tube (16) and finally a ring (3) fixes the disc (18) to the tube (16) by contact of the collars.

(The fixation of the disc (FIG. 1, (18)) to the separation tube (FIG. 1, (16)) can be realized by thread, it can also be fixed to (4) with or without fixation means (5), for example: (18) comprising barrettes fixed to (4) allowing the flow back of the compressed air through the space between the barrettes).

3. Fix one of the two covers (FIG. 1, (19)) to the hermetic frame (FIG. 1, (4)).

4. place the flanged and threaded (FIG. 1, (13)) of rotation, including the sequence propeller and potentially that of backflow (FIG. 1, (6+7)) tighten the assembly nut (11), (the sequence propeller is placed at the limit of contact with the disc (FIG. 1, (18)) and the tube (FIG. 1, (16)).

((6+7) can be shaped in one piece, or composed).

For example: 10 propellers (by laser cutting) of 1 m/m thickness each, fixed solidly together in a helicoidal form.

5. Close the hermetic frame with the other cover (FIG. 1, (10)), which comprises compression valve (8), pressure-relief valve (14) and reinforcement plate (12).

6. Fix the outlet of the motor (FIG. 1, (M)) to the flanged and threaded axis (13) of rotation while fixing the motor (M) to the thruster.

7. Compress the air inside the hermetic frame via the compression valve (FIG. 1, (8)) by an air compressor.

Once these processes are complete, all is needed is acceleration by the motor (FIG. 1, (M)) to engage the thrust.

However, other models can be presented by several sets of expulsion. Nevertheless, whatever the choice of the model, the quantity of compressed air within the hermetic frame and the motive power are also determining factors for the development of the thrust.

Therefore, the system of a sequential impulse thruster is functional from a motive power of motor (M) fed to the input of the system which relates to an electric or magnetic motor. However, whatever type of motor (M) is coupled to this new system; it must match the present of invention.

However, the magnetic motor presents the assets necessary for the good functioning of the system, such as: the supply of a permanent and controlled motive force to the flanged and threaded axis of rotation, the fixing of the motor (M) to the hermetic frame allows the thruster to keep its pressure, and also allows the device to which the thruster applies a permanent thrust in an atmospheric space and/or outside the Earth's atmosphere.

According to the present invention, the system of a sequential impulse thruster can be presented in various embodiments and combinations. However, whatever the embodiment or combination of this new system, it keeps the same characteristic features mentioned by the sequential impulse thruster.

What is claimed is:

1. A sequential impulse thruster, wherein the sequential impulse thruster is intended to produce a thrust by expelling compressed air within a hermetic frame, and the sequential impulse thruster comprises two covers, a compression valve, a pressure-relief valve, a reinforcement plate, a flanged and threaded axis of a rotation to supply a driving force, a backflow source and at least one expulsion set,
wherein each expulsion set consists of a perforated disc with holes and a sequence propeller,
wherein the sequence propeller is fixed while being carried by the flanged and threaded axis of the rotation, the perforated disc is fixed to support by a thread and mounted by a contact of collars and to a separation tube, the contact of the collars is fixed by a ring,
wherein the separation tube is fixed to the hermetic frame by a fixation means having a diameter smaller than a diameter of the hermetic frame, a space between the separation tube and the hermetic frame allows a potential backflow propeller to flow back expelled air towards n expulsion source of the expelled air by an outlet of a compressed air flow,
wherein the compressed air within the hermetic frame is expelled in sequential impulses through the holes of the perforated disc towards a space between fins of the sequence propeller, the compressed air expelled in the sequential impulses causes a repulsion of the perforated disc during a supply of a motive power of a motor actuating the flanged and threaded axis of the rotation.

2. The sequential impulse thruster according to claim 1, wherein the space between the fins of the sequence propeller allows the compressed air to be expelled in the sequential impulses through the holes of the perforated disc and allows an arrival of the compressed air flow to the backflow source.

3. The sequential impulse thruster according to claim 2, an expulsion of the compressed air in the sequential impulses is granted by the fins of the sequence propeller during the supply of the motive power of the motor actuating the flanged and threaded axis of the rotation, and a width of a fin between two alignments of respective holes is equal to a diameter of the respective holes.

4. The sequential impulse thruster according to claim 3, wherein the fins in the sequence propeller are shaped so that each of the fins has a shadow on a following fin, and that each of the fins has a facet.

5. The sequential impulse thruster according to claim 4, wherein one of two surfaces composing the perforated disc comes close to a limit of a contact with the facet of each of the fins, wherein the fins are exposed to the one of the two surfaces by the sequence propeller so that the facet of each of the fins closes and then opens the holes of the perforated disc, and that the compressed air is expelled in the sequential impulses through the holes of the perforated disc during the supply of the motive power of the motor actuating the flanged and threaded axis of the rotation.

6. The sequential impulse thruster according to claim 5, wherein the compressed air flow is replaced by a compressed fluid or by a set of particles releasing a pressure within the hermetic frame of the sequential impulse thruster.

7. The sequential impulse thruster according to claim 6, wherein the compressed air flow is looped and rebalances instantly a pressure between the expulsion source and the backflow source within the hermetic frame, a volume of the compressed air flow expelled in the sequential impulses through the holes of the perforated disc towards the backflow source is equal to a volume of the compressed air flow flowed back towards the expulsion source through the outlet of compressed air flow.

8. The sequential impulse thruster according to claim 7, a rotating motor coupled with the flanged and threaded axis drives the sequential impulse thruster and allows the sequential impulse thruster to maintain a pressure within the hermetic frame and to produce the thrust.

9. The sequential impulse thruster according to claim 8, wherein the thrust results from an opposition between the expulsion of the compressed air in the sequential impulses at a moment of a release of the compressed air through the holes of the perforated disc and the repulsion of the perforated disc, and the holes of the perforated disc and the space between the fins are optionally replaced by other geometric forms.

10. A method of using a sequential impulse thruster or a group of the sequential impulse thrusters in an aerospace vehicle, a navigating vehicle, a rolling vehicle, or a machine generating electricity, wherein
each of the sequential impulse thruster comprises at least one expulsion set, each of the expulsion set consists of a perforated disc having holes and a sequence propeller,
wherein the sequence propeller is fixed while being carried by a flanged and threaded axis of a rotation, a drive motor, the perforated disc is fixed to support by a thread and mounted by a contact of collars to a separation tube, the contact of the collars is fixed by a ring,
wherein the separation tube is fixed to a hermetic frame by a fixation means having a diameter smaller than a diameter of the hermetic frame, a space between the separation tube and the hermetic frame allows a potential backflow propeller to flow back expelled air towards an expulsion source of the expelled air by an outlet of a compressed air flow,
wherein the air compressed flow within the hermetic frame is expelled in sequential impulses through the holes of the perforated disc within the hermetic frame, and
the sequential impulse thruster or the group of the sequential impulse thrusters is a component and an inseparable part of the aerospace vehicle, the navigating vehicle, the rolling vehicle, or the machine generating electricity.
